(19) United States
(12) Patent Application Publication
(10) Pub. No.: US 2008/0174533 A1
(43) Pub. Date: Jul. 24, 2008

(54) Display device and button design thereof

(75) Inventors: Chia-Huang Huang, Banciao City (TW); Tung-Yang Hu, Taoyuan Shien (TW)

Correspondence Address: RABIN & Berdo, PC, 1101 14TH STREET, NW, SUITE 500, WASHINGTON, DC, 20005, US

(73) Assignee: Quanta Computer Inc., Tao Yuan Shien (TW)

(21) Appl. No.: 11/727,715

(22) Filed: Mar. 28, 2007

(30) Foreign Application Priority Data
Jan. 19, 2007 (TW) 96201179

(51) Int. Cl. G09G 3/36

(52) U.S. Cl. 345/87

(57) ABSTRACT

A display device is described. An upper casing and a lower casing are assembled to form a unitary casing to secure an LCD panel. A circuit board is disposed within the unitary casing and around the LCD panel. A first button is disposed on the upper casing for actuating a first switch on the circuit board along a direction perpendicular to the LCD panel. A second button is disposed on the lower casing for actuating a second switch on the circuit board along a direction in parallel with the LCD panel.

### RELATED APPLICATIONS

This application claims priority to Taiwan Application Serial Number 96201179, filed Jan. 19, 2007, which is herein incorporated by reference.

### BACKGROUND

1. Field of Invention

The present invention relates to a display device. More particularly, the present invention relates to an LCD display device.

2. Description of Related Art

As a notebook computer rapidly develops, various functions are added to satisfy all kinds of demands. Scarce space on the notebook computer is available for adding more components. Various functions cannot be controlled entirely by a standard keyboard. Thus, buttons are designed in the area around the LCD panel. How buttons are installed in this narrow area and conveniently operated by users needs more efforts involved.

### SUMMARY

A display device comprises the following components. An upper casing and a lower casing are assembled to form a unitary casing to secure an LCD panel, wherein the upper casing exposes the LCD panel. A circuit board is disposed within the unitary casing and around the LCD panel, wherein the circuit board comprises a first switch and a second switch. A first button is disposed on the upper casing for actuating the first switch along a direction perpendicular to the LCD panel. A second button is disposed on the lower casing for actuating the second switch along a direction in parallel with the LCD panel.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 illustrates a top view of a display device according to one embodiment of this invention;

FIG. 2 illustrates a cross-sectional view taken along the line B-B′ in FIG. 1;

FIG. 3 illustrates a cross-sectional view taken along the line A-A′ in FIG. 1;

FIG. 4 illustrates a top enlarged view of a display device with its upper casing removed according to one embodiment of this invention; and

FIG. 5 illustrates a top view of a display device in FIG. 4 with a circuit board removed.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

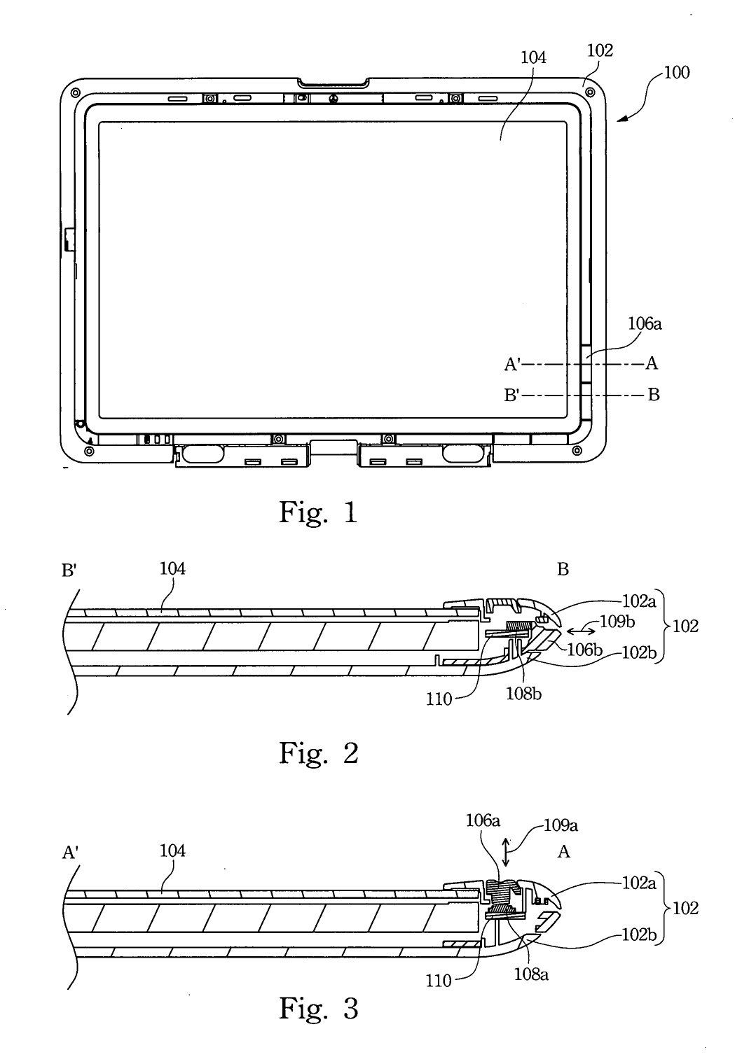

FIG. 1 illustrates a top view of a display device according to one embodiment of this invention. FIG. 2 illustrates a cross-sectional view taken along the line B-B′ in FIG. 1. FIG. 3 illustrates a cross-sectional view taken along the line A-A′ in FIG. 1.

Please refer to FIGS. 1-3. A display device 100 can be an LCD Monitor or a display portion of a notebook computer, palm-sized computer, PDA or other electronic devices. The display device 100 includes an LCD (Liquid Crystal Display) panel 104 to output visual information. The LCD panel 104 is secured in a unitary casing 102, which is assembled by an upper casing 102a and a lower casing 102b. The upper casing 102a exposes the LCD panel 104 such that visual information output by the LCD panel 104 can be visible. In order to insure that buttons can be grouped in a dense area of the display device 100, buttons 106a are disposed on the upper casing 102a and buttons 106b are disposed on the lower casing 102b. Therefore, users can touch buttons 106a and buttons 106b more convenient than all buttons disposed on the upper casing 102a.

The button 106a actuates a switch 108a along a direction 109a perpendicular to the LCD panel 104. The button 106b actuates a switch 108b along a direction 109b in parallel with the LCD panel 104.

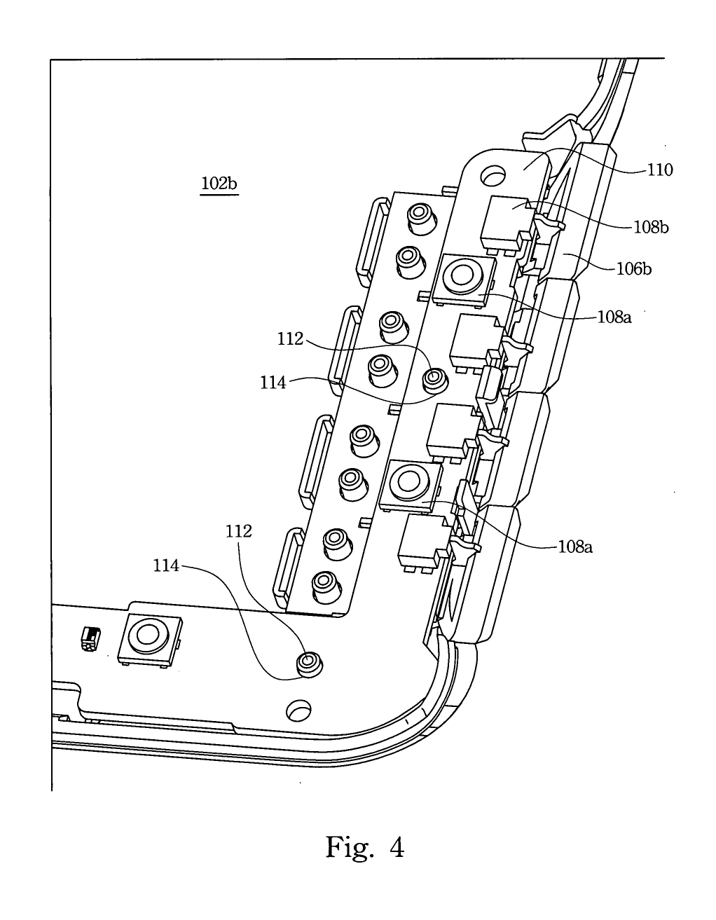

FIG. 4 illustrates a top enlarged view of the display device 100 with its upper casing 102a removed. Please refer to FIGS. 2-4. The switch 108a and the switch 108b are disposed on one side (upper side) of a circuit board 110, which is disposed within the unitary casing 102 and around the LCD panel 104, to be actuated (pressed). When the switch 108a and the switch 108b are actuated, control signals are generated to perform various functions of the display device 100. The circuit board 110 has several position holes 114 to engage with corresponding position pins 112 of the lower casing 102b such that the circuit board 110 can be easily secured and positioned within the unitary casing 102.

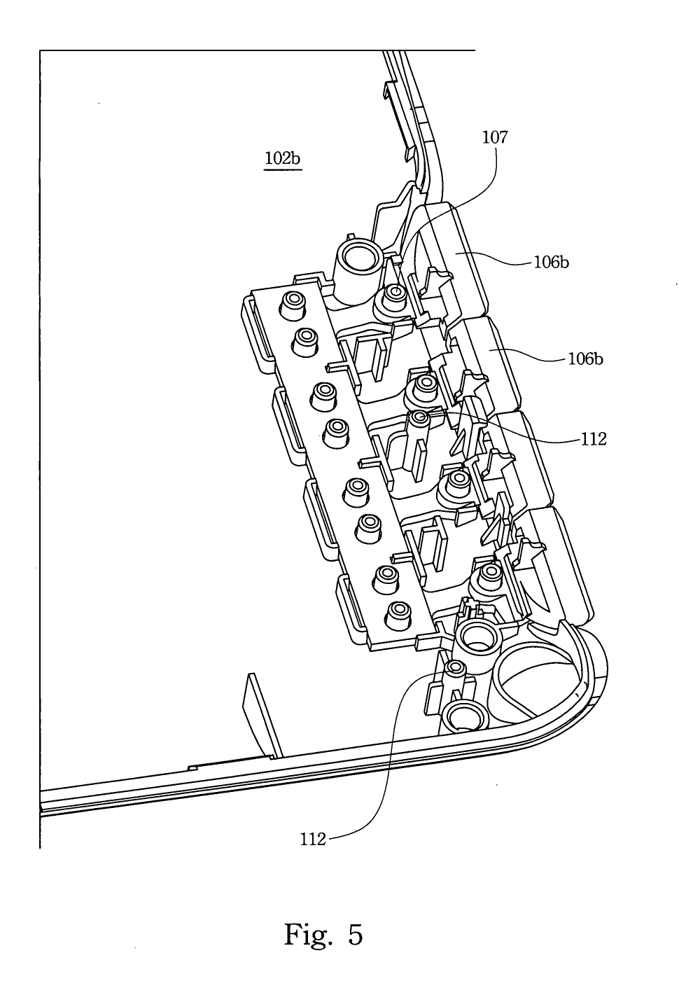

FIG. 5 illustrates a top view of a display device 100 in FIG. 4 with the circuit board 110 removed. The unitary casing 102 (including the upper casing 102a and the lower casing 102b), the button 106a and the button 106b all can be made from plastic materials for the purpose of lightweight and easy fabrication. The button 106b is directly welded to the lower casing 102b by a connection member 107 without adding any piece of spring. When the button 106b is pressed, the deformed plastic button 106b is capable of being recovered to an original shape.

According to embodiments discussed above, the display device of the present invention provides two different buttons actuated along different directions such that buttons are easily grouped in a dense area to be conveniently operated users.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A display device, comprising:
an LCD panel;
an upper casing and a lower casing, being assembled to form a unitary casing to secure the LCD panel, wherein the upper casing exposes the LCD panel;
a circuit board, disposed within the unitary casing and around the LCD panel, wherein the circuit board comprises a first switch and a second switch;
a first button, disposed on the upper casing for actuating the first switch along a direction perpendicular to the LCD panel; and
a second button, disposed on the lower casing for actuating the second switch along a direction in parallel with the LCD panel.

2. The display device of claim 1, wherein the upper casing and the lower casing are made from plastic materials.

3. The display device of claim 1, wherein the first button is made from plastic materials.

4. The display device of claim 1, wherein the second button is made from plastic materials.

5. The display device of claim 1, wherein the first switch and the second switch are disposed on one side of the circuit board.

6. The display device of claim 1, wherein the lower casing comprises a plurality of position pins.

7. The display device of claim 6, wherein the circuit board comprises a plurality of position holes to engage with the plurality of position pins of the lower casing.
